(19) United States
(12) Patent Application Publication
(10) Pub. No.: US 2015/0000698 A1
(43) Pub. Date: Jan. 1, 2015

(54) METHOD FOR CLEANING UP POWDER OR OTHER CONTAMINANTS

(71) Applicant: Barney Boynton, Provo, UT (US)

(72) Inventor: Barney Boynton, Provo, UT (US)

(21) Appl. No.: 13/931,557

(22) Filed: Jun. 28, 2013

(51) Int. Cl. B08B 7/04; B08B 3/08; B08B 3/04

(52) U.S. Cl. CPC B08B 7/04; B08B 3/04; B08B 3/08
USPC 134/6; 134/42; 134/21; 134/26; 134/29

(57) ABSTRACT

Methods are presented for cleaning and removing powder or other substances which may result from a Color Run™-style event or from other events or circumstances. In one embodiment, a contamination area, i.e., an area where powder or some other substance has been disseminated, is cleaned by plugging one or more storm drains, using water to wash the powder into the storm drain(s), and then relocating the contaminated water from the storm drain(s) into one or more sewer drain(s) or other acceptable location(s). Additional steps may include pre-cleaning the anticipated contamination area, using a sweeper vacuum to clean up the powder, pre-washing the anticipated contamination area, pre-cleaning the storm drain(s), closing access to storm drains that will not be used, pre-treating with a sodium hypochlorite solution, and/or pretreating with a brine solution.

### BACKGROUND

Recently, an event known as a Color Run™ has become popular in the United States and other areas. A Color Run™-style event is a fitness run in which the course includes several “Color Zones.” At each Color Zone, event organizers, employees, or volunteers disseminate a colored powder onto event participants. The colored powder often comprises dyed food-grade corn starch, and colors the event participants' skin and clothing. A Color Run™-style event additionally may include a color festival at the conclusion of the run at which event participants disseminate, frequently by throwing into the air, colored powder provided by event organizers.

When the fun has ended, event organizers must deal with cleanup of the colored powder. Although using water to wash the colored powder down existing storm drains would be a convenient solution, in virtually every municipality or jurisdiction laws or regulations prohibit or severely restrict washing anything except water into storm drains.

Previously, cleanup crews have attempted to clean up the colored powder by using regenerative air street sweepers and then washing residue colored powder into storm drains. However, such methods are unsatisfactory for several reasons: (1) they are labor intensive, (2) they fail to adequately remove the colored powder, and (3) they cause undesirable dissemination, rather than containment, of the colored powder. Additionally, such ineffective methods risk ground water contamination resulting from discharge into storm drains. What is needed is a method for cleanup of Color Run™-style events—or any circumstance involving disseminated powder or other substances—that overcomes and/or mitigates these shortcomings.

### SUMMARY

The present invention relates to methods for cleaning and removing powder or other substances which may result from a Color Run™-style event or from other events or circumstances. In one embodiment, a contamination area, i.e., an area where powder or some other substance has been disseminated, is cleaned by plugging one or more storm drains, using water to wash the powder into the storm drain(s), and then relocating the contaminated water from the storm drain(s) into one or more sewer drain(s) or other acceptable location(s). Additional processes may include one or more of, in any combination, pre-cleaning the anticipated contamination area, using a sweeper vacuum to clean up the powder, prewashing the anticipated contamination area, pre-cleaning the storm drain(s), closing access to storm drains that will not be used, pre-treating with a sodium hypochlorite solution, and/or pretreating with a brine solution.

In an additional embodiment, a contamination area is cleaned by using a sweeper machine apparatus equipped with a vacuum system. Additional processes may comprise the additional processes described above, as well as spraying the contamination area with a light mist of a sodium hypochlorite solution when only a light dusting or residue of powder remains. Details regarding embodiments, variations, and additional steps are described below.

### BRIEF DESCRIPTION OF THE DRAWINGS

FIG. 1 depicts an exemplary contamination area that may result from a Color Run™-style event, or from any event or circumstance that may result in dissemination of powder or other substance.

FIG. 2 depicts the processes of one exemplary embodiment of the present invention.

### DETAILED DESCRIPTION OF EXAMPLE EMBODIMENTS

The present invention relates to methods for effectively cleaning and removing powder remaining after Color Run™-style events, or some other substance which has been disseminated over some area as a result of an event or circumstance. In the following discussion, the term “contaminant” refers to powder, colored powder, or any other substance that may be disseminated over an area. The methods of the present invention may improve on currently employed methods by making cleanup less labor-intensive, less expensive, and more effective by removing a greater amount of the dyed corn starch.

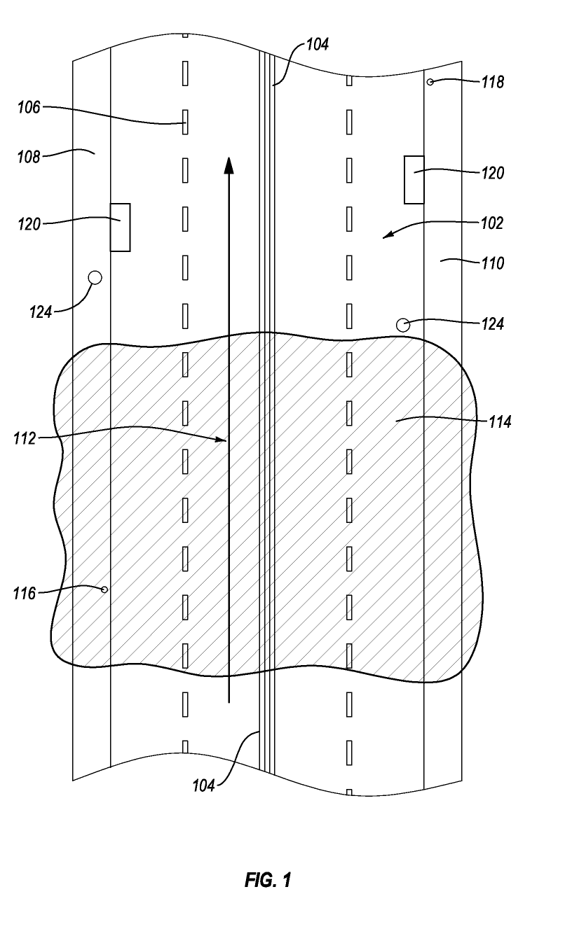

FIG. 1 illustrates an exemplary contamination area 114 along with the area surrounding the contamination area 114. The area depicted in FIG. 1 is exemplary of an area that may result from dissemination of a contaminant. It should be understood that FIG. 1 is merely exemplary, and the invention disclosed herein is applicable to areas of widely varying characteristics.

FIG. 1 depicts a bidirectional street 102, with double-yellow lines 104 separating the two opposite directions of traffic flow, and with dashed lines 106 dividing the lanes for each direction of traffic flow. Sidewalks 108 and 110 represent the sidewalks along the respective sides of street 102. The arrow 112 represents downward slope 112 of street 102. Slope 112 is merely exemplary; the invention disclosed herein applies to widely varying topographies. Contamination area 114 represents an area where contaminant has been disseminated. Water supply(-ies) 116 and 118 illustrate location(s) of one or more exemplary water supply(-ies) such as a fire hydrant or spigot. It is generally irrelevant whether water supply 116 and/or water supply 118 are inside of contamination area 114. Storm drain(s) 120 illustrate exemplary location(s) where one or more storm drains may be located. Sewer drain(s) 124 illustrate location(s) where one or more exemplary sewer drain(s) may be located.

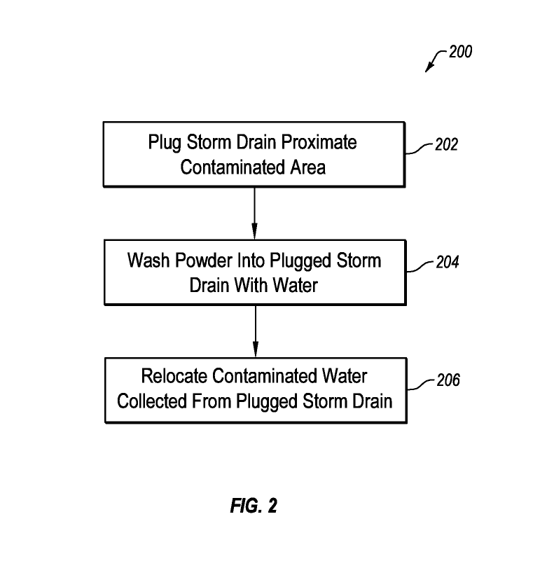

In a first embodiment, and with reference to FIG. 2, a cleanup crew plugs 202 one or more storm drains 120, uses water to wash 204 disseminated contaminant from contamination area 114 into the plugged storm drain(s) 120, and then relocates 206 the resulting contaminated water from the plugged storm drain(s) 120 into a sewer system or other final cleanup location. Access to the sewer system is usually obtained through one or more sewer drains 124.

The cleanup crew strategically selects storm drain(s) 120 to plug by reviewing the contamination area 114 (e.g., the area in and/or around a Color Zone which has been or will be contaminated with colored powder from a Color Run™-style event, or contaminated with some other contaminant), and identifying storm drain(s) 120 into which colored powder will flow when the contamination area 114 is washed with water or receives water from another source, e.g., natural precipitation. Factors affecting identification of storm drain(s) 120 include but are not limited to topography, curbs, fields, sidewalks, and other manmade features.

Additionally, determining which storm drain(s) 120 to plug will be affected by the location of one or more sanitary/sewer drain access(es) 124 which may be used to dispose of contaminated cleanup water collected in plugged storm drain pipes and/or conduit. Proximity to one or more selected sewer drain access(es) 124 increases the convenience of this embodiment as described below.

There are varied methods for plugging storm drain(s) 120. In one exemplary method, one or more flexible expandable waterproof objects are used to plug a circular storm drain pipe or conduit. Such plugs are widely and commonly available as exercise, yoga, or Pilates™ balls or similar items. Such plugs are expandable and contractible, commonly through inflation or deflation with air from a pumping apparatus. Plugs with other means for expanding and/or contracting may also be used. The size of such a plug is selected so that the plug completely fills a storm drain pipe when expanded, but may be moved through a storm drain pipe in when in a deflated or contracted state.

In order to plug the storm drain(s) 120, storm drain pipes or passages are generally accessed by removing a ground-level grate or cover, although the storm drain pipes or conduits may be accessed by any means as appropriate based on the particular setup or design of a storm drain system.

A determination must additionally be made regarding the precise location in the storm drain pipe or conduit to place the plug. In general, this determination is made by analyzing the anticipated contamination zone along with the location(s) of the storm drain(s) 120, and determining how much storm drain pipe/conduit volume (i.e., temporary reservoir volume) is sufficient to store the amount of water that will collect as a result of washing the contamination area 114 or as a result of water or liquids from other sources, e.g., natural precipitation. Placing a plug at a greater distance from a storm drain 120 increases the available volume of storage for contaminated water in a particular storm drain pipe or conduit. Plugs may be secured and tethered to prevent undesired movement from forces such as static pressure.

When the selected storm drain(s) 120 have been plugged, water is used to wash the contaminant into the one or more plugged storm drain(s) 120. Water may be conveniently obtained from one or more water supplies 116. A water supply 116 may comprise a fire hydrant, an outdoor or indoor water spigot, a water truck, or any other water source. A water meter may be attached to a selected fire hydrant or other water source 116, and hoses may be connected to a fire hydrant or other water source 116 through the water meter. Washing the contaminant into or toward the selected storm drain(s) 120 is accomplished by generally known methods of using water from a hose or other apparatus to wash debris, in this case contaminant, in a desired direction, e.g., into one or more storm drain(s) 120.

When the contaminant has been washed into the one or more plugged storm drain(s) 120, the contaminated water in the plugged storm drain(s) 120 is relocated into the one or more selected sewer/sanitary drain access(es) 124. This relocation may be accomplished in several ways.

In one preferred embodiment, a pump is used to relocate the contaminated water from a plugged storm drain 120 into a sewer/sanitary drain 124 or into any other acceptable disposal system. Many varieties of pumps are generally available. In one preferred embodiment, the pumping apparatus has at least two hoses, one for intaking the contaminated water from the one or more plugged storm drains, and one for expelling the contaminated water from the hose into the sewer/sanitary drain access. Exemplary pumping systems include but are not limited to self-priming submersible pumps and contractor pumps. A person of ordinary skill will recognize that many types of pumping systems or apparatuses may be used to relocate the contaminated water from one or more plugged storm drain(s) 120 into one or more sewer/sanitary drain(s) 124. Of course, relocating the water may be accomplished with means other than a pumping system, such as by using buckets or Shop-Vacs to place the contaminated water in a container or bucket and then relocating (by carrying or any other means) the container or bucket to a sewer/sanitary drain access 124 and discharging the contents of the container/bucket into sewer/sanitary drain 124.

Several optional processes may improve and/or enhance the methods disclosed herein. Such optional processes include but are not limited to a pre-cleaning process and a sweeper process.

One optional process comprises a pre-clean prior to dissemination of contaminant in the contamination area. The pre-clean promotes more efficient cleanup by removing debris that may collect contaminant or detract from the cleanup steps described herein. Several techniques may be used to accomplish a pre-clean. One pre-clean process comprises using specialized sweeping equipment to capture and dispose of foreign material, e.g., dirt, leaves, garbage, sticks, in an anticipated contamination area 114. Another pre-clean step comprises a prewash/rinse into a storm drain system or into any other acceptable discharge system. Such a prewash may be accomplished using water from a fire hydrant, water truck, or other water source using generally known techniques of using water to wash debris and contaminants off of the ground of an anticipated contamination area 114.

Another optional pre-cleaning process comprises pre-cleaning the storm drain(s) 120 in the areas where plugs will be installed. Pre-cleaning the storm drain(s) may be accomplished by removing debris/foreign objects where a plug will be installed, especially the area between a storm drain access 120 and the location in the storm drain system where a plug is to be installed. Conducting such a pre-cleaning of a storm drain 120 helps to ensure that a plug optimally and/or completely seals a storm drain 120 and/or conduit.

Another optional pre-cleanup step comprises closing access to storm drain system accesses that will not be part of the plug system. Determining which storm drains to close off may comprise identifying storm drain accesses in the vicinity of the contamination area which do not need to be or will not be plugged, and which may receive some contaminated water during cleanup.

An additional optional pretreatment step comprises treating an anticipated contamination area 114 with a sodium hypochlorite solution or a similar substance. This pretreatment may inhibit powder or other substance from sticking to the asphalt and/or concrete (and other surfaces) in an anticipated contamination area 114. The sodium hypochlorite solution may comprise a range of chemical to water ratios, depending on the circumstances. One possibility is to mix an approximately 10-15% sodium hypochlorite solution with water in a ratio of approximate 100-200 parts water to 1 part 10-15% sodium hypochlorite. These ratios and dilution percentages are only approximations; other ratios and dilution percentages are possible depending on the characteristics of the area where the solution is to be applied and possibly also depending on the characteristics of the contaminant.

An additional optional pretreatment step comprises treating an anticipated contamination area 114 with a proprietary brine solution, which is applied to the ground/surface area of an anticipated contamination area 114 in an amount sufficient to coat the ground surface and then evaporate. The remaining brine residue bonds with the powder or other substance, increasing the effectiveness of a sweeping cleanup. The brine solution may comprise salt dissolved in water. For example, many feed stores sell livestock salt supplement with trace minerals and selenium. This or another salt substance may be dissolved in water to make a brine solution. An exemplary brine solution may comprise approximately 1 lb. of salt for every 4-10 gallons of water. This ration is exemplary and other ratios will also work depending on the specific characteristics of location, weather, contaminant, and other factors.

In an additional embodiment, cleanup begins (after preparing the contamination area 114, pretreating/pre-cleaning, plugging drains, etc., as described herein above) by using a sweeper machine apparatus that is equipped with a vacuum system. The vacuum system may additionally comprise a filter system. Exemplary machines include the Tenent™ and Advance™ brand three-wheeled ride-on sweepers with dust control and vacuum containers. Other similarly functioning machines may also be employed to sweep and/or vacuum a contamination area 114. Use of a combination sweeping and vacuum system provides the benefit of cleaning most (if virtually not all) of the dyed corn starch up, powder, or other substance prior to a more thorough cleanup step. While sweeping without a vacuum system may provide some benefit, such benefit may be undermined by the sweeper's tendency to spread powder into the air, thereby undoing cleanup progress. Using a sweeper combined with a vacuum system removes most, if not virtually all, of the residue powder or other substance before a follow-on cleanup step. Depending on the unique circumstances of each cleanup situation, use of a sweeper/vacuum system may completely obviate the need for some or all additional cleanup steps. Even if some water cleanup is still necessary after use of the sweeper/vacuum, the amount of water is generally significantly decreased and minimized such that a water cleanup step may be performed in significantly less time and with significantly less water than if no sweeper/vacuum system had been employed.

Another optional cleanup step comprises spraying contamination area 114 with a light mist of sodium hypochlorite solution when only a light dusting or residue of contaminant remains. Applying sodium hypochlorite solution to contamination area 114 may be accomplished through the use of tools or devices such as backpack pump sprayers, downstream solution applicators, and premixed solution in a water trailer/truck equipped with a spraying/misting apparatus. Applying sodium hypochlorite solution to colored contaminant, including dyed corn starch residue, has the effect of bleaching the contaminant. The sodium hypochlorite solution may comprise a range of chemical to water ratios, depending on the circumstances. One possibility is to mix an approximately 10-15% sodium hypochlorite solution with water in a ratio of approximate 100-200 parts water to 1 part 10-15% sodium hypochlorite. These ratios and dilution percentages are only approximations; other ratios and dilution percentages are possible depending on the characteristics of the area where the solution is to be applied and possibly also depending on the characteristics of the contaminant.

Because corn starch is a natural and nontoxic product, after it is bleached it will be dispersed through natural wind currents or air flow, usually within minutes or hours at most. Therefore, many cleanups may be completed by simply applying a light mist of sodium hypochlorite to remaining residue of colored powder in contamination area 114. The step of applying sodium hypochlorite solution may be applied whether or not a water cleanup step is employed. If a water cleanup step is employed, sodium hypochlorite solution may be employed after the water has dried/evaporated if there remains any contaminant, e.g., colored powder such as dyed corn starch, in contamination area 114. In most cases, application of sodium hypochlorite solution will not be necessary if a water cleanup step is employed. Often, after performing a sweeper/vacuum step, application of sodium hypochlorite solution will be sufficient to complete cleanup of contamination area 114.

As described above, if a water cleanup step is employed, then it is also necessary to plug storm drain(s) 120, wash the colored powder into the plugged storm drains, and pump or relocate the contaminated cleanup water from plugged storm drains 120 into a sewer/sanitary drain system access 124. Other described steps may be employed as appropriate and described herein.

In some circumstances, water cleanup using sewer drains may be unnecessary. A determination that sewer-drain-water-cleanup is unnecessary may be based on one or more factors such as the predicted efficacy of non-water cleanup methods (as described herein), and a sufficiently minimal likelihood of rain, precipitation, or water from other sources. Upon a determination that water cleanup is unnecessary, it is not necessary to plug drains, relocate water, close access to storm drain accesses, or perform other steps that are specific to water cleanup. When no water is used (and is not present as a result of rain or other outside sources), cleanup may be accomplished by optionally pre-treating contamination area 114 with the brine solution, using the sweeper/vacuum and, and then applying sodium hypochlorite solution to the residue after the sweeper/vacuum step. If necessary, multiple iterations of any of the steps disclosed herein may be performed.

Other embodiments or variants of the steps described herein may also be applied. For example, it may be necessary to obtain licenses or similar approvals from local or governing authorities to use storm drain systems, sewer/sanitary drain systems, water supplies, or other aspects of this invention.

Some storm drain systems are constructed of pipe or conduit that is not circular or substantially circular in shape. In such circumstances, the pipes/conduit may be plugged by using custom constructed plugs where needed. Custom plugs may comprise combinations of other plugs or any other object that is capable of plugging pipe or conduit.

Additionally, a disseminated contaminant may comprise substances and coloring agents other than dyed food-grade corn starch. The methods and steps disclosed herein may be employed analogously to other variants of contaminants such as powders, colored powders, other substances, and/or coloring agents.

The steps and methods disclosed here may be altered and/or modified to account for rainfall or other precipitation. When a weather forecast calls for rain, storm drain systems may be plugged as described herein. In general, any modestly sized pump, e.g., a pump with a two-inch discharge line, is sufficient to relocate contaminated water from a temporary storm drain reservoir into a sewer system at the rate that potentially contaminated rainwater enters a temporary storm drain reservoir. In the event of a pump failure, generator failure, or the event of a 1000-year storm event, the storm drain plugs may be equipped with above grade tethers for fast removal of the plug without entry into a storm drain access.

The methods and steps disclosed herein are not limited to Color Run™-style events, but may be employed in other cleanup circumstances where it is desirable to cleanup a disseminated contaminant. Exemplary circumstances may include substance spills, vehicle crashes with fluid spills, and hazardous waste containment such as gas, oil, hydraulic fluid, pesticide, etc. Additionally, the brine-solution pretreatment disclosed herein could be applied as a pretreatment under varied circumstances.

Although the disclosure herein frequently references “Color Run™-style events,” a person of ordinary skill will appreciate that the methods disclosed herein apply to any situation requiring cleanup of a disseminated contaminant.

What I claim is:

1. A method for substantially removing a contaminant from a contamination area, comprising:
identifying one or more reservoirs capable of holding a liquid;
using water to wash a substantial portion of the contaminant from the contamination area into the one or more reservoirs; and
relocating the water used to wash a substantial portion of the contaminant from the one or more reservoirs into a disposal system.

2. The method of claim 1, wherein identifying one or more reservoirs comprises creating one or more temporary reservoirs capable of holding a liquid.

3. The method of claim 1, wherein the contaminant is powder.

4. The method of claim 1, wherein the contaminant in the contamination area results from a Color Run™-style event.

5. The method of claim 2, wherein creating one or more temporary reservoirs comprises installing one or more plugs in a storm drain system.

6. The method of claim 5, wherein one of the one or more plugs comprises a flexible expandable waterproof object.

7. The method of claim 6, wherein the flexible expandable waterproof object is an exercise, yoga, or Pilates™ ball.

8. The method of claim 1, wherein relocating the water used to wash the contaminant comprises using a pump system to move the water used to wash the contaminant from the one or more reservoirs into the acceptable disposal system.

9. The method of claim 1, wherein the disposal system is a sewer system.

10. The method of claim 1, additionally comprising pretreating the contamination area prior to contamination, wherein pretreating comprises one or more of pre-cleaning the contamination area, pre-washing the contamination area, pre-rinsing the contamination area, pre-sweeping the contamination area, sealing one or more storm drain accesses in or near the contamination area, treating the contamination area with a sodium hypochlorite-based solution, or treating the contamination area with a brine solution.

11. The method of claim 1, additionally comprising applying a discoloring agent to the contaminant.

12. The method of claim 11, wherein the discoloring agent is a sodium-hypochlorite-based solution.

13. A method for cleaning a contamination area where contaminant is disseminated, comprising applying a discoloring agent to the contaminant.

14. The method of claim 13, additionally comprising removing a portion of the contaminant by sweeping and/or vacuuming.

15. The method of claim 14, wherein removing a portion of the contaminant by sweeping and/or vacuuming includes using a sweeper machine equipped with a vacuum system.

16. The method of claim 13, wherein the contaminant results from a Color Run™-style event.

17. The method of claim 13, additionally comprising using water to wash/rinse the contaminant toward a desired location, wherein the desired location may include a storm drain, a sewer drain, or other reservoir capable of holding a liquid in or near the contamination area.

18. The method of claim 13, wherein the contaminant is a powder.

19. The method of claim 13, wherein the discoloring agent is a sodium hypochlorite-based solution.

20. The method of claim 13, additionally comprising pretreating the contamination area prior to contamination, wherein the pretreating comprises at least one of pre-cleaning the contamination area, pre-washing the contamination area, pre-rinsing the contamination area, pre-sweeping the contamination area, sealing one or more storm drain accesses in or near the contamination area, treating the contamination area with a sodium hypochlorite-based solution, or treating the contamination area with a brine solution.
